(19) United States
(12) Patent Application Publication
(10) Pub. No.: US 2020/0292692 A1
(43) Pub. Date: Sep. 17, 2020

(54) GLOBAL NEAREST NEIGHBOR (GNN) BASED TARGET TRACKING AND DATA ASSOCIATION

(71) Applicant: BAE SYSTEMS Information and Electronic Systems Integration Inc., Nashua, NH (US)

(72) Inventors: Quang M. LAM, Fairfax, VA (US); Ryan P. CARNEY, Manchester, NH (US); Ned B. THAMMAKHOUNE, Manchester, NH (US)

(73) Assignee: BAE SYSTEMS Information and Electronic Systems Integration Inc., Nashua, NH (US)

(21) Appl. No.: 16/299,474

(22) Filed: Mar. 12, 2019

(51) Int. Cl. G01S 13/72; G06K 9/62; F41H 7/02

(52) U.S. Cl. CPC G01S 13/726; G06K 9/6276; B64C 39/024; G06K 9/6288; F41H 7/02

(57) ABSTRACT

A modified GNN/DA subsystem processes angle only measurements from at least two sensors (but can be replicated to n sensors using a similar track fusion framework per sensor as a local track center and then fusing them via a multiple local track fusion architecture) to reconstruct a complete battle space picture consisting of multiple moving targets. In some cases, the sensor is an EO/IR camera and the moving targets are UAVs. The modified GNN/DA is used as part of a Fire Control Solution (FCS) either implemented on a ground-based vehicle or on-board a projectile.

### FIELD OF THE DISCLOSURE

The present disclosure relates to multiple target tracking (MTT) and more particularly to using a global nearest neighbor (GNN) based target tracking and data association techniques for many on many ground to air missions.

### BACKGROUND OF THE DISCLOSURE

Solving the Data Association (DA) problem for short (e.g., less than about 300 m altitude) ground to air missions pose certain challenges. This is particularly true when the only passive sensors (e.g., EO/IR sensors) are employed since it compounds the GNN complexity when solving the DA for tracking multiple moving targets using (passive) angle only measurements. Typically, the miss distance for conventional systems is on the order of 30 m.

Wherefore it is an object of the present disclosure to overcome the above-mentioned shortcomings and drawbacks associated with the conventional target tracking and data association techniques.

### SUMMARY OF THE DISCLOSURE

It has been recognized that multiple target detection and tracking in the presence of target dynamic uncertainties using angle only targeting sensors (i.e., passive EO/IR camera) have remained as an active research area. In one embodiment of the present disclosure, an angle only sensor based GNN/DA solution as a real time MTT subsystem provides a highly accurate TSE in the form of track files or a track list capturing multiple targets' state vectors to feed a guidance subsystem and a weapon to target assignment (WTA) algorithm to address time critical target engagement in a many on many mission.

One aspect of the present disclosure is an improved multiple target detection and tracking (MTT) system comprising: two or more sensors, each sensor located on a ground based vehicle such that the two or more sensors are configured to capture angle only measurements for a ground to air mission using a modified global nearest neighbor/data association (GNN/DA) algorithm, the modified GNN/DA comprising: a data association (DA) scheme to pair individual sets of angle only measurements from individual targets detected by individual sensors using an Extended Kalman Filter (EKF) of individual target state estimators (TSE) residing in a track file management (TFM) module of each ground based vehicle; an interface between output from the TFM and a fire control system (FCS) guidance subsystem and a weapon to target assignment (WTA) module for engagement of multiple weapons with multiple individual targets; each sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to the guidance subsystem to complete an engagement: process images from the two or more sensors on each of the two or more ground vehicles in real-time; detect one or more target location measurements for one or more individual targets using the images from the two or more sensors each on one of the two or more ground vehicles to produce potential target tracks; process the one or more target location measurements to determine if the one or more target location measurements from the two or more sensors each on one of the two or more vehicles are correlated with predicted target tracks via the fire control system, if not, then uncorrelated target tracks are placed in a separate file for possible new target track initiation/creation; associate the potential target tracks via a gating system, wherein potential target tracks falling within a gating threshold are chosen as active target tracks; update and maintain active target tracks as part of the track file management (TFM) system, as target state estimates for the multiple individual targets; feed output from the track file management (TFM) system to the weapon target assignment (WTA) system to guide each of the multiple weapons onto a collision course with one of the one or more targets by pairing the correct active target track with correct one or more targets.

One embodiment of the improved multiple target detection and tracking (MTT) system is wherein the two or more sensors are EO/IR cameras. In some cases, the ground based vehicle is a tank.

Another embodiment of the improved multiple target detection and tracking (MTT) system is wherein if active target tracks created in the track file management (TFM) system have not received continuous measurement updates for more than three consecutive samples, the tracks are deleted. In some cases, an active track file management (TFM) system contains all active target tracks.

Another aspect of the present disclosure is a method of data association in a multi-weapon/multi target system, comprising: processing images from at least one sensor mounted on a ground based vehicle in real-time, wherein there are two or more vehicles and each sensor is part of a fire control subsystem (FCS), the at least one sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to a guidance subsystem to complete an engagement; detecting one or more target location measurements for one or more individual targets using the images from the at least one sensor to produce potential target tracks; processing the one or more target location measurements to determine if the one or more target location measurements from the at least one sensor are correlated with predicted target tracks via the fire control system, if not, then uncorrelated target tracks are placed in a separate file for possible new target track initiation/creation; associating the potential target tracks via a gating system, wherein the potential target tracks that fall within a gating threshold are chosen as active target tracks; updating and maintaining the active target tracks as part of the track file management (TFM) system, as target state estimates for the individual targets; feeding output from the track file management (TFM) system to a weapon target assignment system (WTA); pairing an active target track with a correct individual target; and feeding output from the track file management (TFM) system to the weapon target assignment (WTA) system to guide multiple weapons onto a collision course with respective multiple individual targets by pairing the correct active target track with the correct individual targets.

One embodiment of the method of data association in a multi-projectile/multi target system is wherein the at least one sensor is an EO/IR camera. In certain embodiments, the ground based vehicle is a tank.

Another embodiment of the method of data association in a multi-projectile/multi target system is wherein uncorrelated target tracks are declared as clutters and no new track is initiated or created if new target location measurements do not persist across continuous samples.

Still yet another embodiment of the method of data association in a multi-projectile/multi target system is wherein if active target tracks created in the track file management (TFM) system have not received continuous measurement updates for more than three consecutive samples, the tracks are deleted.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a diagram of one embodiment of a system according to the principles of the present disclosure.

FIG. 2 is a diagram of one embodiment of a system according to the principles of the present disclosure.

FIG. 3 is a diagram of one embodiment of a multiple target tracking (MTT) system according to the principles of the present disclosure.

FIG. 4A, FIG. 4B, and FIG. 4C are a block diagram of one embodiment of the system of the present disclosure.

FIG. 5A, FIG. 5B, and FIG. 5C are plots of position error estimates in x, y, and z directions, respectively, for one embodiment of the system of the present disclosure.

FIG. 6 shows validation of one embodiment of the modified global nearest neighbor (GNN) for multiple sensors fusion and tracking according to the principles of the present disclosure.

FIG. 7A, FIG. 7B, and FIG. 7C are plots of velocity error estimates in x, y, and z directions, respectively, for one embodiment of the system of the present disclosure.

### DETAILED DESCRIPTION OF THE DISCLOSURE

In certain embodiments of the present disclosure a sensor (e.g., an EO/IR camera) mounted on a ground-based vehicle (e.g., a tank) captures multiple moving targets' (e.g., UAVs) measurements in its field of view (FOV). In some cases, these measurements have no label/identity associated with each of them at the sensor output level and are not in an appropriate format ready to support a Guidance, Navigation, and Control (GN&C) system for engagement execution. In some embodiments, some of the measurements originate from real targets and some do not (e.g., clutters or friendly platforms). To process these “no label” angle only measurements (i.e., azimuth and elevation angles) and correctly reconstruct or estimate the trajectories of these objects/targets from these two angles measurements requires the following: 1) to select a robust target state estimator (TSE) design and implement it in a multiple extended Kalman filter (EKF) track file system to accurately estimate individual target's motion trajectories and manage them in a frame by frame manner to support real-time engagement decisions; and 2) to implement the correct data association (DA) function to achieve the correct measurement to each individual target state estimation (TSE) pairing for proper TSE track update.

In one embodiment of the present disclosure, a modified GNN based DA algorithm is employed with specific settings on a gating threshold and with multiple robust angle only EKF implementation as a track file management system to resolve the track file management for the detection and tracking of multiple moving targets observed by a sensor (e.g., an EO/IR camera).

Global Nearest Neighbor (GNN) based design is well known to the multiple target tracking (MTT) community; however, using GNN properly for a short range ground to air application is challenging due to the following reasons: 1) need for selection and sizing for the gating threshold for sensor, EO/IR camera, angle only measurements; 2) DA logic setting to allow the multiple TSEs to maintain their motion trajectory in a high precision manner; and 3) TSE structuring in a dynamic track file management system to timely support the correct engagement decision. In one embodiment of the present disclosure, the GNN based design achieves a high precision picture for an individual sensor (e.g., EO/IR camera) and captures frame by frame motion of multiple moving targets observed by the sensor. In certain embodiments, an interface between a multiple target tracking (MTT) framework and a guidance, navigation and control (GNC) subsystem of individual projectiles allows for dynamic interactions between the targeting sensor, as part of the MTT and a weapon to target assignment (WTA) framework, and the guidance subsystem action to successfully achieve an engagement mission goal.

In one embodiment, a modified GNN/DA is present as a real time solution to be used as part of the Fire Control Subsystem (FCS) and it can be implemented either on-board the weapon or on the ground as part of the FCS. Such a solution does not currently exist for angle only EO/IR sensors to detect, track, and provide highly accurate TSE solutions to the guidance law in the presence of MTT.

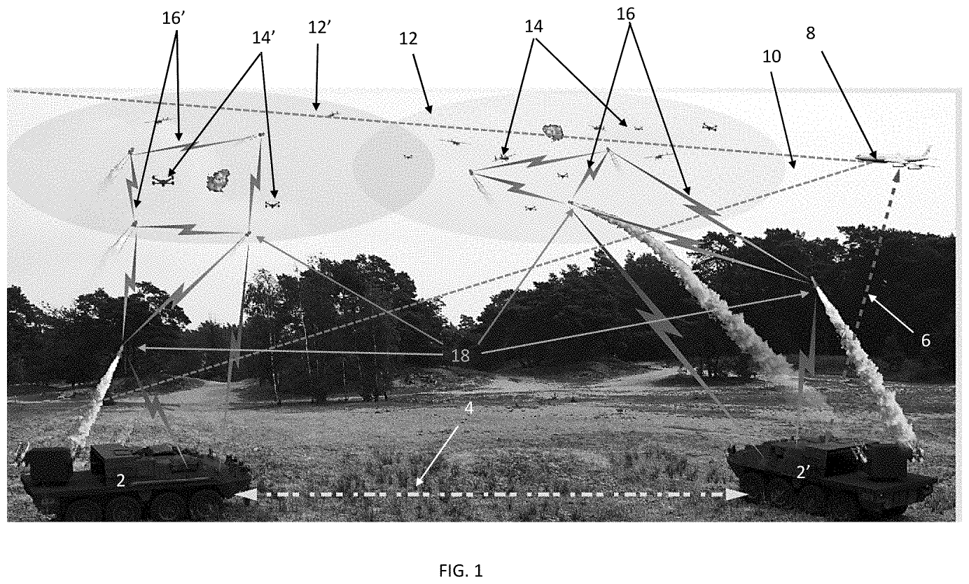

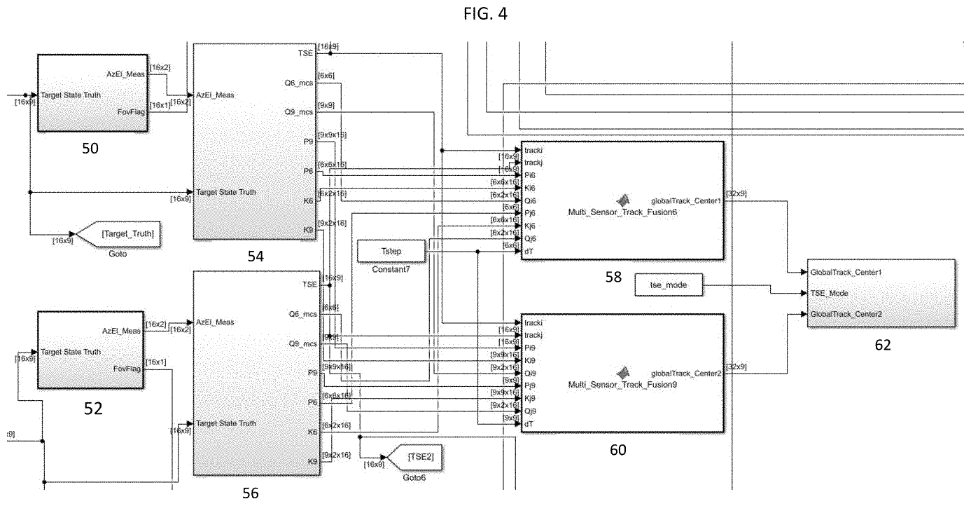

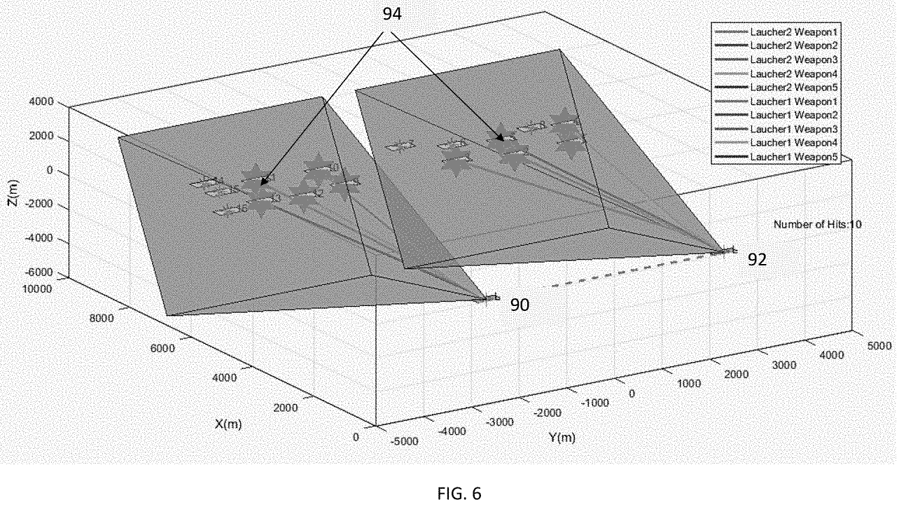

Referring to FIG. 1, a diagram of one embodiment of a system according to the principles of the present disclosure is shown. More specifically, one embodiment of a system according to the principles of the present disclosure with a modified global nearest neighbor/data association (GNN/DA) as a key component of the fire control solution (FCS) is shown having one or more vehicles (2, 2′) located on the ground each is spaced some distance away from the other 4. The one or more ground based vehicles are in two-way communication 6 with one or more air-based vehicles 8. In some cases, these one or more air-based vehicles are the friendly force UAVs serving as an air based battle space data collection and relaying their scene collected data to ground based vehicles via a data link as illustrated as element 10. Individual sensors (e.g., EO/IR camera) FOVs capture multiple moving (e.g., UAVs) targets (14, 14′) illustrated as within each ground vehicle's individual target space (12, 12′). This data is fused and integrated using the modified GNN/DA subsystem as shown in FIG. 4. In one embodiment, the modified GNN/DA algorithm of the present disclosure was implemented using a many on many engagement modeling and simulation system, the results of which are shown in FIG. 6.

In certain embodiments, the system of the present disclosure is implemented as an onboard GNN/DA software block as part of the FCS residing on the ground based vehicle that serves as an integral component of an overall weapon guidance, navigation and control (GNC) system to interact with a weapon to target assignment (WTA) block (e.g., a ground-based and onboard combination) in order to achieve multiple simultaneous targets engagement capability known as a multiple simultaneous engagement technology (MSET) capability.

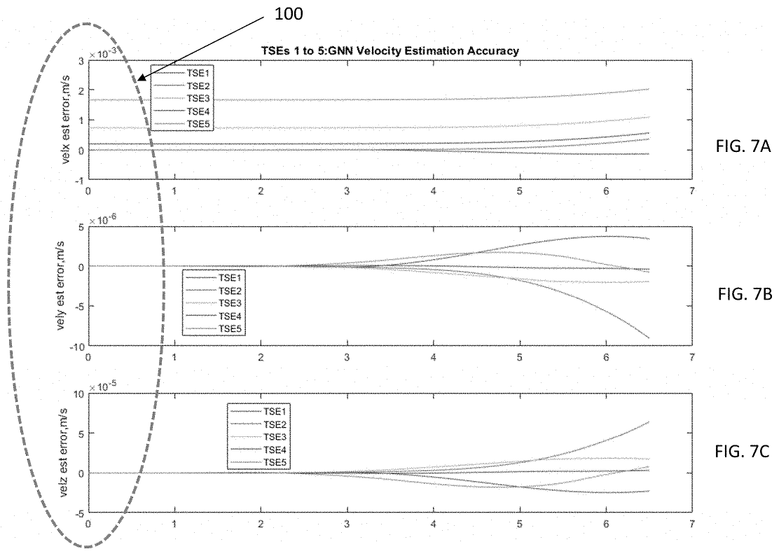

Referring to FIG. 1 and FIG. 7, multiple guided projectiles 18 are commanded to engage with respective targets 14, 14′ (e.g., UAVs) their respective trajectories are accurately computed and reconstructed utilizing the multiple target track files output by the proposed GNN/DA block by feeding these track files into the projectiles' guidance and WTA to properly identify and locate the one or more moving targets for engagement. A complex many on many engagement simulation, according to the WTA principles of the present disclosure, has been validated with an onboard EO/IR camera as the sensor hosted on the ground vehicles' platform (see FIG. 6).

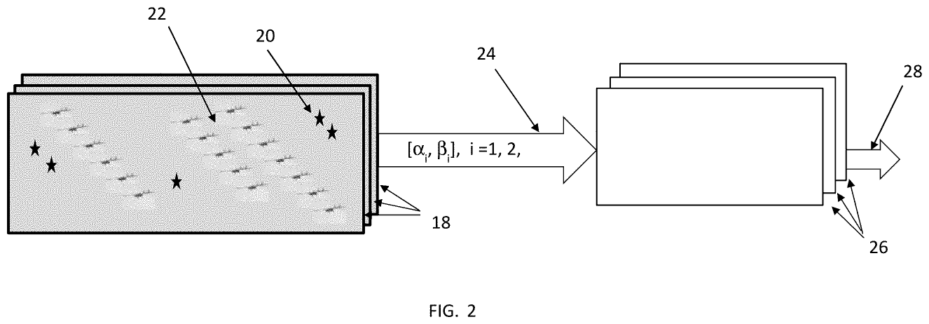

Referring to FIG. 2, a diagram of one embodiment of a system of multiple EO/IR cameras fusion according to the principles of the present disclosure is shown. More specifically, multiple passive EO/IR sensors collecting MTT measurements as multiple sets of azimuth and elevation angles (i.e., relative geometric angles from each individual target to the individual sensor's state vector) are output of the multiple targeting sensors.

A plurality of measurement frames 18 captured within a sensor's FOV at each output capture cycle capture the one or more moving targets 22. In one embodiment, the sensor is an EO/IR camera mounted on a ground-based vehicle.

Still referring to FIG. 2, multiple moving objects in space with respect to individual EO/IR camera on the ground are captured as angle measurements (i.e., azimuth and elevation angles, [α,β] 24). These multiple sets of angle measurements (unlabeled and that is why they need to be “sorted,” or associated, with the right TSE by the DA function) and have no direct correlation with existing track files computed by the GNN/DA subsystem. In certain embodiments, the DA function properly pairs each set of angle measurements with the correct TSE residing in the track file of the GNN/DA subsystem for proper TSE updates using newly provided angle only measurements. This subsequently produces a bank of multiple target state estimations 26, where the TSE is via an AO EKF. These TSEs are used to support real-time engagement decisions 28 (i.e., dynamic weapon to target assignment). In certain embodiments of the system, multiple targets are engaged by multiple projectiles such that there is a many on many correlation taking full advantage of the number of projectiles available to avoid a situation where two or more projectiles engage the same target and thus miss an opportunity to engage as many targets as possible.

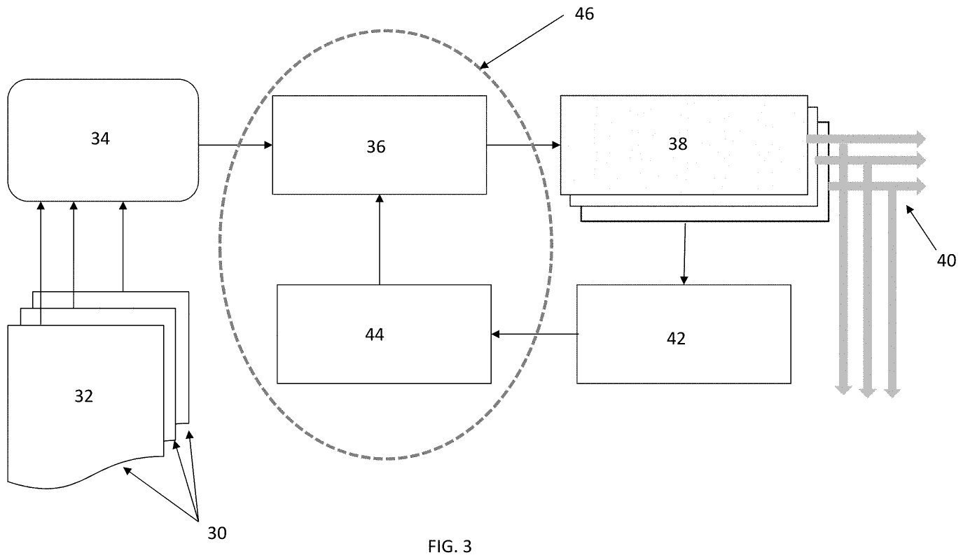

Referring to FIG. 3, a diagram of one embodiment of a multiple target tracking (MTT) system according to the principles of the present disclosure is shown. More specifically, individual sensors 30, each mounted on a different vehicle, collectively form a group of distributed sensors 32. These distributed sensors 32 perform data preprocessing and measurement formation steps within a sensor processing module 34. The sensor processing module output is fed into a modified GNN/DA framework 46, comprising a sensor measurement to target estimate fusion module (i.e., the front end of the DA) 36 and a gating computation module 44.

Referring to FIG. 3, track initiation, confirmation, and deletion are managed in a track maintenance module 38. Filtering and prediction is conducted in an EKF module 42. In some cases the angle only EKF calculation is with six states or with nine states. In certain embodiments, the process is iterative to track multiple moving objects. Once a track is confirmed, the data is sent to guidance and control for use with weapon to target and sensor handoff processes 40. In some cases, single picture compilation using multiple track fusion actions occur on local data fusion centers located on each vehicle.

In one embodiment of the GNN algorithm of the present disclosure, either a six state or 9 state model is used, where function [X_k_new, P_k_new, ekf_out]=GNN_DA(X_k, P_k, y_k, Q, R, dT)

%% Global Nearest Neighbor (GNN) Data Association

%% Parameters

gateLevel=1*pi/180; % Angle Error Gating

[trackNum, state]=size(X_k);

[nMeas, sizeMeas]=size(y_k);

%% 1) Allocate memory for GNN DA Processor

% initialize parameters for current time step

X_k_new=zeros(size(X_k));

P_k_new=zeros(size(P_k));

Z_k=zeros(size(X_k));

G_EKF_comp=zeros (state, sizeMeas, trackNum);

ekf out=zeros (size(X_k));

fovCount=0; % use to evaluate fov stats

DistM=1000*ones(trackNum,nMeas); % TrackNum and number of measure are the same in some cases

res=ones(trackNum, nMeas, sizeMeas);

%% 2) Estimate State Using 6 State MCS EKF

for i=1:trackNum

X_in=X_k(i,:)′;

P_in=P_k(:,:,i);

y_in=y_k(i,:)′;

[X_out, P_out, y_p, S, K, Z_out]=ekf_6(X_in, P_in, Q, R, dT, y_in);

X_k_new(i,:)=X_out;

P_k_new(:,:,i)=P_out;

Z_k(i,:)=Z_out′;

G_EKF_comp(:,:,i)=K;

ekf_out(i,:)=X_out;

%% 3) Statistical Distance & Residual

for j=1:nMeas

y_m=y_k(j,:)′;

if any(y_m)

fovCount=fovCount+1;

[DistM(i,j), res(i,j,:)]=gaussian_prob (y_m, yp, S, 2); % i is track index, j is valid data indexend

%% 4) Apply Gate Threshold

DistLabels=DistM<gateLevel; % Gate satisfaction criterion

end

%% 5) Track Assignment

for i=1:trackNum

ValidAssociatedInd=find(DistLabels(i,:));

if ˜isempty(ValidAssociatedlnd) % if pass the threshold test

if numel(ValidAssociatedInd)>1

[˜, midx]=min(DistM(i,ValidAssociatedlnd));

% Reduce ValidAssociatedlnd to one with minimum label

ValidAssociatedInd=ValidAssociatedlnd(midx);

end

%% 6) Propagate Estimated State Based on Track Assignment

K=G_EKF_comp(:,:,i);

e=squeeze(res(i,ValidAssociatedInd,:));

Z_temp=Z_k(i,:)′+K*e; % update predicted state estimate (n×1)

X_k_temp=f_x(Z_temp);

X_k_new(i,:)=X_k_temp′;

end

function [p, y_hat]=gaussian_prob(y_m, y_p, S, use_log)

% p=gaussian_prob(x, m, C, use_log)

% y_m seeker measurement (az, el)

% y_p EKF estimate(az_hat, el_hat)

% S Output Covariance Matrix of the EKF

% Evaluate the multi-variate density with mean vector m and covariance

% matrix C for the input vector x.

% Vectorized version: Here X is a matrix of column vectors, and p is

% a vector of probabilities for each vector.

% Design and analysis of modern tracking system by Blackman & Popoli, 1999

if nargin<4

use_Jog=0;

End

M=length(y_p);

denom=(2*pi)\hat{ }(M/2)*sqrt(abs(det(S))); % pg. 354

y_hat=y_m−y_p;

d2=y_hat′*S\hat{ }(−1)*y_hat; % eq. 6.7 pg 329

switch use_log

case 0

numer=exp(−0.5*d2);

p=numer/denom; % pg. 335

case 1

p=−0.5*d2−log(denom); % ref to eq(6.29)

case 2

p=d2;

otherwise

error(‘Unsupported log type’)

end

Referring to FIG. 4A-FIG. 4C, a block diagram of one embodiment of the system of the present disclosure are shown. More specifically, the flowchart illustrates how angle only measurements information from two EO/IR cameras are being processed and fused at individual local track fusion centers and then globally fused to produce the total track files of the entire battle space. In FIG. 4A, a pair of sensors (50, 52) are shown processing target state truth data and outputting FOV flags and angle measurements (e.g., Az, El). A first GNN/DA module 54 processes data from a first sensor 50, and a second GNN/DA module 56 processes data from a second sensor, etc. In FIG. 4B, both a 6 state 58 and a 9 state 60 multi sensor track fusion module are implemented. In FIG. 4C, these modules produce global tracks which are fed into a global track fusion module 62 for use by guidance and control for use with weapon to target and sensor handoff processes, for example.

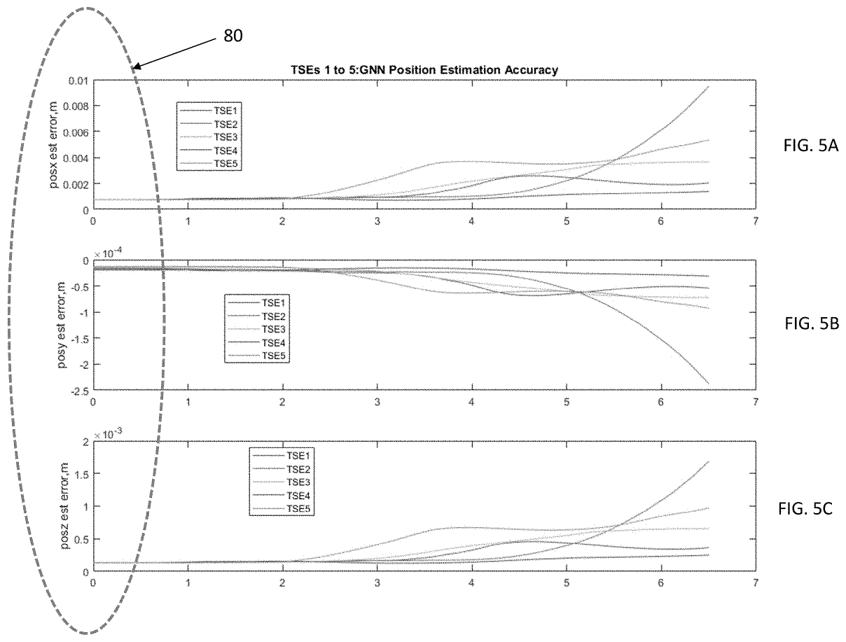

Referring to FIG. 5A, FIG. 5B, and FIG. 5C, plots of position error estimates in x, y, and z directions, respectively, for one embodiment of the system of the present disclosure are shown. More specifically, the position estimate error between an ideal data association (DA) and the GNN DA of the present disclosure 80 is exceptional. The GNN/DA is almost equal to an ideal DA with a miss distance of less than one meter. FIG. 5A represents the five target TSEs position error estimates in the x direction, in meters. FIG. 5B represents the five target TSEs position error estimates in the y direction, in meters. FIG. 5C represents the five target TSEs position error estimates in the z direction, in meters.

Referring to FIG. 6, validation of one embodiment of the modified GNN for multiple sensor fusion and tracking according to the principles of the present disclosure is shown. In one embodiment, the system is used for short range (less than about 300 m altitude) ground to air missions. In some cases, two EO/IR sensors are mounted on two launchers (on respective ground vehicles) and they are tracking multiple UAVs. Highly accurate TSEs of these UAVs are delivered to a Guidance Law subsystem to effectively engage ten weapons for a successful hit of ten targets (as shown in a high fidelity many on many engagement simulation). More specifically, each launcher 90, 92 has five weapons (e.g., projectiles, munitions, bullets). In this simulation, a miss distance criterion of 3 m or less was used. In one embodiment sixteen moving objects (eight within each sensor's field of view) were used, where ten were categorized as targets 94. Each target was engaged by only one weapon, five of each coming from each launcher. The system provides for communication between the various weapons so that accurate engagement is accomplished.

One embodiment of the system of the present disclosure robustly processes angle only sensor measurements in the presence of multiple target motion subject to their dynamic uncertainties (i.e., their origin, target death or birth, etc.) and provides a highly accurate track file solution to be timely connected to a FCS serving as a real time software block to allow the engagement of multiple weapons to multiple targets.

The ability to maintain a highly accurate track file in the presence of MTT uncertainties mentioned above (i.e., clutters, target death, target birth, target acceleration uncertainty, etc.) while supplying the measurements via only passive sensors to report the scene situation is a critical improvement in the context of Multiple Simultaneous Engagement Technology (MSET) missions.

Referring to FIG. 7A, FIG. 7B, and FIG. 7C, plots of velocity error estimates in x, y, and z directions, respectively, for one embodiment of the system of the present disclosure are shown. More specifically, the velocity estimate error between an ideal data association (DA) and the GNN DA of the present disclosure 100 is exceptional. The GNN/DA is almost equal to an ideal DA with a miss distance of less than one meter. FIG. 7A represents the five target TSEs velocity error estimates in the x direction, in meters. FIG. 7B represents the five target TSEs velocity error estimates in the y direction, in meters. FIG. 7C represents the five target TSEs velocity error estimates in the z direction, in meters.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. An improved multiple target detection and tracking (MTT) system comprising:
two or more sensors, each sensor located on a ground based vehicle such that the two or more sensors are configured to capture angle only measurements for a ground to air mission using a modified global nearest neighbor/data association (GNN/DA) algorithm, the modified GNN/DA comprising:
a data association (DA) scheme to pair individual sets of angle only measurements from individual targets detected by individual sensors using an Extended Kalman Filter (EKF) of individual target state estimators (TSE) residing in a track file management (TFM) module of each ground based vehicle;
an interface between output from the TFM and a fire control system (FCS) guidance subsystem and a weapon to target assignment (WTA) module for engagement of multiple weapons with multiple individual targets;
each sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to the guidance subsystem to complete an engagement:
process images from the two or more sensors on each of the two or more ground vehicles in real-time;
detect one or more target location measurements for one or more individual targets using the images from the two or more sensors each on one of the two or more ground vehicles to produce potential target tracks;
process the one or more target location measurements to determine if the one or more target location measurements from the two or more sensors each on one of the two or more vehicles are correlated with predicted target tracks via the fire control system, if not, then uncorrelated target tracks are placed in a separate file for possible new target track initiation/creation;
associate the potential target tracks via a gating system, wherein potential target tracks falling within a gating threshold are chosen as active target tracks;
update and maintain active target tracks as part of the track file management (TFM) system, as target state estimates for the multiple individual targets; and
feed output from the track file management (TFM) system to the weapon target assignment (WTA) system to guide each of the multiple weapons onto a collision course with one of the one or more targets by pairing the correct active target track with correct one or more targets.

2. The improved multiple target detection and tracking (MTT) system according to claim 1, wherein the two or more sensors are EO/IR cameras.

3. The improved multiple target detection and tracking (MTT) system according to claim 1, wherein the ground based vehicle is a tank.

4. The improved multiple target detection and tracking (MTT) system according to claim 1, wherein if active target tracks created in the track file management (TFM) system have not received continuous measurement updates for more than three consecutive samples, the tracks are deleted.

5. The improved multiple target detection and tracking (MTT) system according to claim 1, wherein an active track file management (TFM) system contains all active target tracks.

6. A method of data association in a multi-weapon/multi target system, comprising:
processing images from at least one sensor mounted on a ground based vehicle in real-time, wherein there are two or more vehicles and each sensor is part of a fire control subsystem (FCS), the at least one sensor having an on-board multiple target detection and tracking (MTT), data association (DA), and track file management (TFM) system installed thereon, wherein the multiple target detection and tracking (MTT), data association (DA), and track file management (TFM) system are configured to direct the following operations to deliver one or more correct track files to a guidance subsystem to complete an engagement;
detecting one or more target location measurements for one or more individual targets using the images from the at least one sensor to produce potential target tracks;
processing the one or more target location measurements to determine if the one or more target location measurements from the at least one sensor are correlated with predicted target tracks via the fire control system, if not, then uncorrelated target tracks are placed in a separate file for possible new target track initiation/creation;
associating the potential target tracks via a gating system, wherein the potential target tracks that fall within a gating threshold are chosen as active target tracks;
updating and maintaining the active target tracks as part of the track file management (TFM) system, as target state estimates for the individual targets;
feeding output from the track file management (TFM) system to a weapon target assignment system (WTA);
pairing an active target track with a correct individual target; and
feeding output from the track file management (TFM) system to the weapon target assignment (WTA) system to guide multiple weapons onto a collision course with respective multiple individual targets by pairing the correct active target track with the correct individual targets.

7. The method of data association in a multi-projectile/multi target system according to claim 6, wherein the at least one sensor is an EO/IR camera.

8. The method of data association in a multi-projectile/multi target system according to claim 6, wherein the ground based vehicle is a tank.

9. The method of data association in a multi-projectile/multi target system according to claim 6, wherein uncorrelated target tracks are declared as clutters and no new track is initiated or created if new target location measurements do not persist across continuous samples.

10. The method of data association in a multi-projectile/multi target system according to claim 6, wherein if active target tracks created in the track file management (TFM) system have not received continuous measurement updates for more than three consecutive samples, the tracks are deleted.
